(19) United States
(12) Patent Application Publication
(10) Pub. No.: US 2010/0131971 A1
(43) Pub. Date: May 27, 2010

(54) ADDRESSING THEFT OF CABLE SERVICES AND BREACH OF CABLE SYSTEM AND SECURITY

(75) Inventors: Daniel M. Hegglin, Danville, CA (US); Mark Millet, Mountain View, CA (US)

Correspondence Address: Weaver Austin Villeneuve & Sampson LLP, P.O. BOX 70250, OAKLAND, CA, 94612-0250, US

(73) Assignee: CISCO TECHNOLOGY, INC., San Jose, CA (US)

(21) Appl. No.: 12/276,331

(22) Filed: Nov. 22, 2008

(51) Int. Cl. H04N 7/16

(52) U.S. Cl. 725/25

(57) ABSTRACT

Disclosed are a method and apparatus for addressing theft of cable services and breach of cable system privacy and security. In one example, a method for preventing suspect cable modems from stealing cable services and breaching cable system privacy and security includes (i) determining in a cable modem termination system that a cable modem seeking to access cable services is suspect, wherein it is determined that the cable modem is suspect when such cable modem is attempting or performing one or more of a plurality of predefined suspect activities; (ii) categorizing the cable modem as suspect after it is determined that the cable modem is suspect; (iii) indicating to the cable modem that it has been approved for cable services at a first service level after it is determined that the cable modem is suspect; and (iv) providing cable services to the cable modem at a second service level after it is determined that the cable modem is suspect, wherein the second service level is lower than the first service level.

### BACKGROUND OF THE INVENTION

1. Field of the Invention

The present invention relates to measures for addressing theft of cable services. More specifically, it relates to measures for preventing suspect cable modems from stealing cable services and breaching cable system privacy and security.

2. Description of the Related Art

The cable TV industry has been upgrading its signal distribution and transmission infrastructure since the late 1980s. In the last two decades, the cable industry has developed reliable and efficient two-way transmission of digital data over its cable lines at speeds that are orders of magnitude faster than those available through telephone lines, thereby allowing its subscribers to access digital data for uses ranging from Internet access to cable commuting.

Cable modem technology is in a unique position to meet the demands of users seeking fast access to information services, the Internet and business applications, and can be used by those interested in cablecommuting (a group of workers working from home or remote sites whose numbers will grow as the cable modem infrastructure becomes increasingly prevalent). In sum, cable companies are in the midst of a transition from their traditional core business of entertainment video programming to a position as a full service provider of video, voice and data telecommunication services. Among the elements that have made this transition possible are technologies such as the cable modem.

It is usual for companies that provide cable Internet access to require their customers to either purchase or lease a cable modem. The cable modem is typically an external device that connects to a home PC (Personal Computer) through an Ethernet port or the like. In operation, cable modems communicate via a downstream and an upstream channel with a head end device. The downstream channel is typically allocated a higher transmission rate than the upstream channel. Conventionally, every packet sent by the head end travels downstream on every link to every home; and every packet sent by a home travels on the upstream channel to the head end. For this reason, a wider range of potential security breaches exists in a residential cable system.

The particular vulnerability of cable systems to certain types of attacks has not gone unnoticed by hackers. Over the past years as cable lines have come to constitute an increasingly large portion of the broadband lines in the United States, the number and types of attacks on cable systems has increased. Cable service providers have faced a wide range and variety of attacks, from cloning cable modems by using a cable modem's MAC (media access control) address, to attempts to intercept, modify or substitute authorized cable modem configuration files, to illegally downloading a subscriber's configuration file from a TFTP (Trivial File Transfer Protocol) server, to illegally copying authentication information for BPI (Baseline Privacy Interface) security and privacy registration, among others. Not surprisingly, with the growing threat of breaches of security and theft of services, there has been an increased focus on performance, reliability, and improved maintenance of the security infrastructure of such systems by cable service providers.

However, even after identifying suspicious cable modems, implementing countermeasures can be difficult and can sometimes lead to unintended negative consequences. For example, in many instances, upon identifying a cable modem as suspect, a cable service provider will put the cable modem in a reject state, and communicate that rejection to the cable modem. Legitimate modems will adhere to that restriction. However, often illegitimate modems (for example, cloned modems) will simply reset and try to register the cable modem again and again. Even when these further attempts to register can be thwarted, the resources needed to address these persistent and serial attacks can be expensive for the cable system. As noted above, cable systems can involve the feature of a shared broadcast medium. Accordingly, persistent attacks by a clone to register with a head end may result in reductions to the bandwidth available on the cable links, thus impairing the transmission speed for legitimate communications and data transmissions. In addition, handling these additional registration requests can tie up valuable resources in the cable head end.

Therefore, it would be desirable to provide improved mechanisms for facilitating responses to attempts at theft of cable services, breaches of data security, and other security violations, while reducing the unintended negative consequences of such proposed mechanisms/solutions.

### SUMMARY OF THE INVENTION

Accordingly, apparatus and methods for addressing theft of cable services and preventing breaches of cable system privacy and security are disclosed. In one embodiment, a method for addressing theft of cable services and preventing breaches of cable system privacy and security includes (i) determining in a cable modem termination system that a cable modem seeking to access cable services is suspect, wherein it is determined that the cable modem is suspect when such cable modem is attempting or performing one or more of a plurality of predefined suspect activities, (ii) categorizing the cable modem as suspect after it is determined that the cable modem is suspect, (iii) indicating to the cable modem that it has been approved for cable services at a first service level after it is determined that the cable modem is suspect, and (iv) providing cable services to the cable modem at a second service level after it is determined that the cable modem is suspect, wherein the second service level is lower than the first service level.

In a specific implementation, the first service level is requested by the cable modem. In another implementation, the second service level is a predetermined service level provided by the cable modem termination system to suspect cable modems. In certain embodiments, the second service level comprises a bandwidth allocation and/or a priority profile. In another embodiment, the cable modem is determined to be suspect after the cable modem fails an authentication process a predetermined number of times.

In another embodiment, the invention pertains to an apparatus having at least a processor and a memory. The processor and memory are configured to perform one or more of the above described operations. In another embodiment, the invention pertains to a means plus function apparatus. In certain embodiments, the invention pertains to at least one computer readable storage medium having computer program instructions stored thereon that are arranged to perform one or more of the above described operations.

These and other features and advantages of the present invention will be presented in more detail in the following specification of the invention and the accompanying figures which illustrate by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a block diagram of an example cable system.

FIG. 2 is a diagrammatic representation illustrating example upstream and downstream channels of communication between a cable modem termination system (CMTS) and a cable modem in a two-way cable system.

FIG. 3 is a block diagram illustrating a CMTS in accordance with a specific embodiment of the present invention.

FIG. 4 is a high-level flow chart illustrating one registration process for establishing data communication between a cable modem and a CMTS according to one embodiment of the present invention.

FIG. 5 is a handshaking diagram illustrating ranging related communications between a cable modem and a CMTS establishing a connection between the cable modem and the CMTS according to a specific implementation of the present invention.

FIG. 6 is a handshaking diagram illustrating a series of communications between a cable modem and a CMTS carrying out a cable modem's security and privacy registration according to one embodiment of the present invention.

FIG. 7 is a handshaking diagram illustrating a series of communications between a cable modem and a DHCP server/CMTS carrying out the DHCP protocol 250 in accordance with one embodiment of the present invention.

FIG. 8 is a handshaking diagram illustrating a series of communications between a cable modem and a configuration file server/CMTS carrying out a process for providing a configuration file to the cable modem according to one embodiment of the present invention.

FIG. 9 is a handshaking diagram illustrating a series of communications between a cable modem and a CMTS carrying out a registration request operation of a registration process according to one embodiment of the present invention.

FIG. 10 is a high-level flow chart illustrating a procedure for managing data communication between a cable modem and a CMTS according to one embodiment of the present invention.

FIG. 11 is a flow chart illustrating a method for processing a send or receive request from a cable modem to a CMTS according to one embodiment of the present invention.

FIG. 12 is a diagrammatic representation illustrating the basic components of a Cable Modem Termination System (CMTS).

### DETAILED DESCRIPTION OF SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In some instances, well known process operations have not been described in detail in order not to unnecessarily obscure the present invention. In the following description, numerous specific details are set forth in order to provide a thorough understanding of the present invention. Of course, the field of addressing theft of cable services is such that many different variations of the illustrated and described features of the invention are possible. Those skilled in the art will thus undoubtedly appreciate that embodiments of the invention can be practiced without some specific details described below, and indeed will see that many other variations and embodiments of the invention can be practiced while still satisfying its teachings and spirit. For example, although the present invention is described with reference to particular embodiments of a cable modem registration process under DOCSIS (Data Over Cable Service Interface Specification) 3.0 protocol, it can similarly be embodied in other versions of the DOCSIS Protocol or other cable modem registration processes for data over cable systems.

The processes, features, or functions of the present invention can be implemented by program instructions that execute in any suitable computing device although the following description pertains mainly to embodiments being implemented by a head end or a cable modem termination system (CMTS). Example computing devices include DHCP (Dynamic Host Configuration Protocol) servers, TFTP (Trivial File Transfer Protocol) servers, network computers, network appliances, personal computers, personal digital assistants, game consoles, televisions, set-top boxes, premises automation equipment, point-of-sale terminals, automobiles, personal communications devices, or any combination thereof. The program instructions can be distributed on a computer readable medium, storage volume, and/or the Internet. Program instructions can be in any appropriate form, such as source code, object code, or scripts.

In general, embodiments of the present invention provide a way to respond to theft of cable service or other types of security issues by providing service to suspect cable modems at a lower service level. A cable modem termination system (CMTS) in a cable operator's head end (or any suitable device) can determine whether a cable modem seeking to access cable services is suspect. Such a determination might be based on a finding that a cable modem is attempting or performing one or more of a predefined set of suspect activities. If it is determined that a cable modem is suspect, the CTMS (or any suitable device) may provide service to the cable modem at a lower service level than the CMTS would typically provide for a non-suspect cable modem. For example, the suspect cable modem may be surreptitiously provided with a significantly reduced transmission rate. In certain embodiments, the cable modem is not informed that it is receiving service at a lower level. For instance, the cable modem may still be provided with a configuration file that indicates a normal (not reduced) transmission rate.

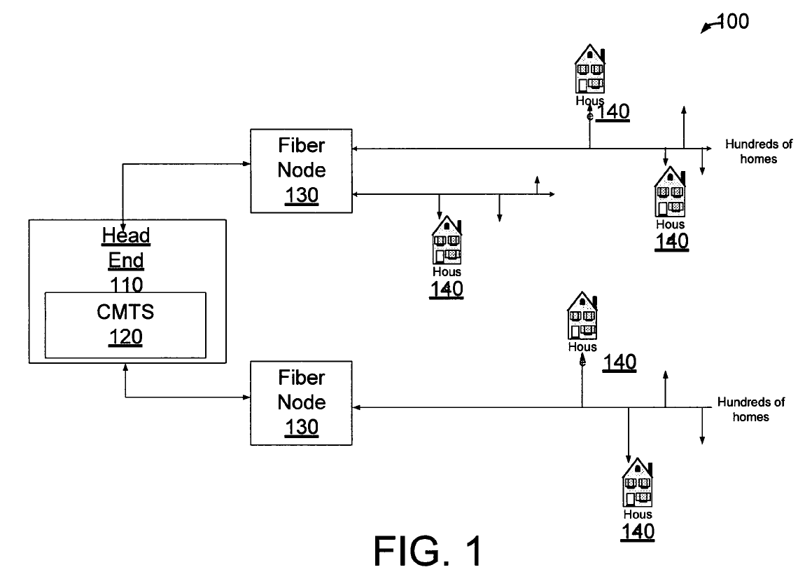

Prior to describing mechanisms for handling theft of cable service or the like, a computer network architecture will first be briefly described to provide an example context for practicing techniques of the present invention. FIG. 1 is a high-level block diagram of a cable system 100 utilizing a cable modem for data transmission according to one embodiment of the present invention. As shown, the cable system can include a head end 110 (e.g., a distribution hub) which can typically service thousands of subscribers. The head end 110 may include a cable modem termination system (CMTS) 120 connected to fiber nodes 130 by pairs of optical fibers. The CMTS can be operable to perform one or more of the following operations: (1) receiving signals from external sources and converting the format of those signals, e.g., microwave signals to electrical signals suitable for transmission over the cable system; (2) providing appropriate Media Access Control (MAC) level packet headers for data received by the cable system, (3) modulating and demodulating the data to and from the cable system, and (4) converting the electrical signal in the CMTS to an optical signal for transmission over the optical lines to the fiber nodes; (5) facilitating the determination of suspected cable modems and responses to such suspect cable modems as described herein.

Head end 110 may be connected through pairs of fiber optic lines (one line for each direction) to a plurality of fiber nodes 130. Each of the fiber nodes 130 may be connected by a coaxial cable to two-way amplifiers or duplex filters which permit certain frequencies to go in one direction and other frequencies to go in the opposite direction. Each fiber node 130 can normally service a plurality of subscribers. Fiber nodes 130, coaxial cable, two-way amplifiers, plus distribution amplifiers along trunk line, and subscriber taps, e.g., branch lines, can make up the coaxial distribution system of a cable system. A subscriber tap may be connected to a cable modem. A cable modem may, in turn, be connected to a subscriber computer.

In certain embodiments, cable systems can be used for two-way transmission of data. The data may be Internet data, digital audio, or digital video data, in MPEG format, for example, from one or more external sources. Such data access networks can serve as extensions of the typical cable network used for broadcasting cable television.

Data on the upstream and downstream channels can be carried over radio frequency (RF) carrier signals. Cable modems are devices that convert digital data to a modulated RF signal and convert the RF signal back to digital form. The conversion can be performed at two points: at the subscriber's home by a cable modem and by a CMTS located at the head end. The CMTS can be configured to convert digital data to a modulated RF signal which is carried over the fiber and coaxial lines to the subscriber premises. The cable modem can then demodulate the RF signal and feed the digital data to a computer. On the return path, the operations may be reversed. The digital data can be fed to the cable modem which converts it to a modulated RF signal. Once the CMTS receives the RF signal, the CMTS can demodulate the signal and transmit the digital data to an external source.

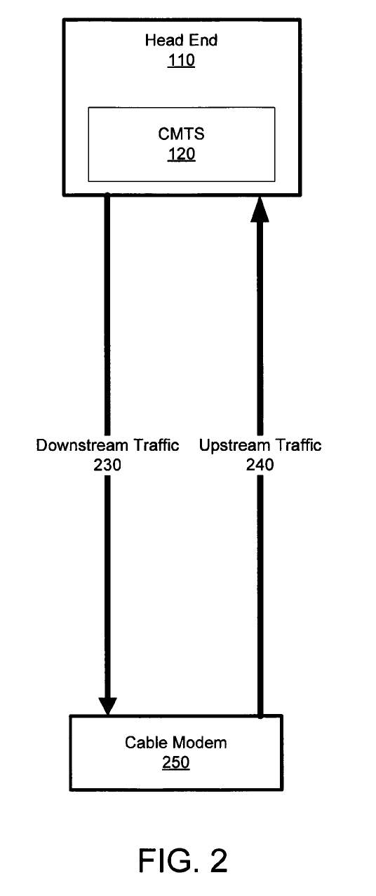

FIG. 2 is a high-level block diagram of a two-way cable system 100 utilizing a cable modem for data transmission according to one embodiment of the present invention. The system 100 can include two data paths (downstream 230 and upstream 240) between a cable modem 250 and a CMTS 120 that allows for the two-way transmission of digital data.

In order for a two-way HFC cable system to provide digital communications, subscribers are typically equipped with cable modems 250. The cable modem 250, an improvement of a conventional PC data modem, can provide this high speed connectivity so as to allow the cable system to take the form of a full service provider of video, voice and data telecommunications services. To access cable services, a subscriber typically first buys or leases a cable modem 250, registers the cable modem with a local cable system, connects an RF coaxial cable to the cable modem, and connects the cable modem to an Ethernet port (or the like) on his/her personal computer. These steps can serve to connect the subscriber's computer to the cable system. However, the cable modem typically then performs a registration process with the CMTS 120 before such cable modem can actually send or receive data.

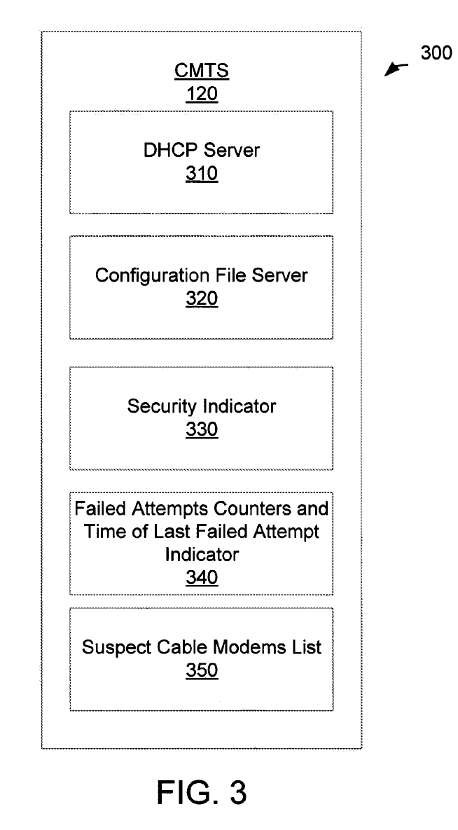

FIG. 3 is a block diagram illustrating a cable modem termination system (CMTS) 300 in accordance with one embodiment of the present invention. This illustration of a CMTS's components is not exhaustive; there may be additional components, and all of the components may not be necessary. In addition, some or all of the components may not be located within the CMTS; they may be located in a separate location that is connected to the CMTS in some way.

Referring back to FIG. 3, the CMTS 300 may include an authorized DHCP server 310. The DHCP server (or any server described herein) may be implemented as a separate device from the CMTS or integrated into the CMTS. The DHCP server may be responsible for carrying out the DHCP processes described above. Second, the CMTS 300 may also include (or have access to) a configuration file server 320, in which the configuration files of the different cable subscribers may be stored. The configuration file server 320 may download configuration files to cable modems when cable modems submit read requests with configuration filenames to the server. Although not pictured in FIG. 3, the CMTS may also include (or have access to) a time of day server.

In addition, the CMTS may include (or have access to) a security indicator 330 for each cable modem indicating if the modem has failed the security and privacy registration process (described further below). The security indicator (or any other variable or constant described herein) may be stored in any suitable number or type of memory devices or databases that are implemented separately or integrated within the CMTS. In some embodiments, the security and privacy registration may be based on the Baseline Privacy Interface (BPI) protocol. The CMTS may also include (or have access to) failed attempts counters and time of last failure attempt indicators 340. A failed attempts counter 330 may be used to keep track of the number of times a cable modem 250 fails each authentication step. A time of last failed attempt indicator may allow cable operators to reset the failed attempts counters to zero if a cable modem has not failed an authentication step for a given period of time, for example, 24 hours. The CMTS may further include (or have access to) a suspect cable modems list that keeps track of identifying information, for example, MAC addresses, for the cable modems which are deemed to be suspect.

The description of a CMTS provided above and in FIG. 3 concerns only one embodiment of the components that may exist in the CMTS 120. It is foreseen that other components may be utilized and different variations of the illustrated and described features of the invention may be possible.

In general, certain embodiments of the present invention include techniques for determining whether a cable modem is suspect so as to provide a lower level of service to such cable modem. Any suitable criteria may be utilized to determine whether a cable modem is suspect and is to be given a lower level of service. Additionally, such determination process may be performed during any suitable time with respect to a particular cable modem. By way of examples, it may be determined whether a cable modem is suspect during one or more of the following communication processes between a cable modem and a CMTS: a registration process, a ranging process, a security or privacy registration process, or a process for requesting and providing a configuration file.

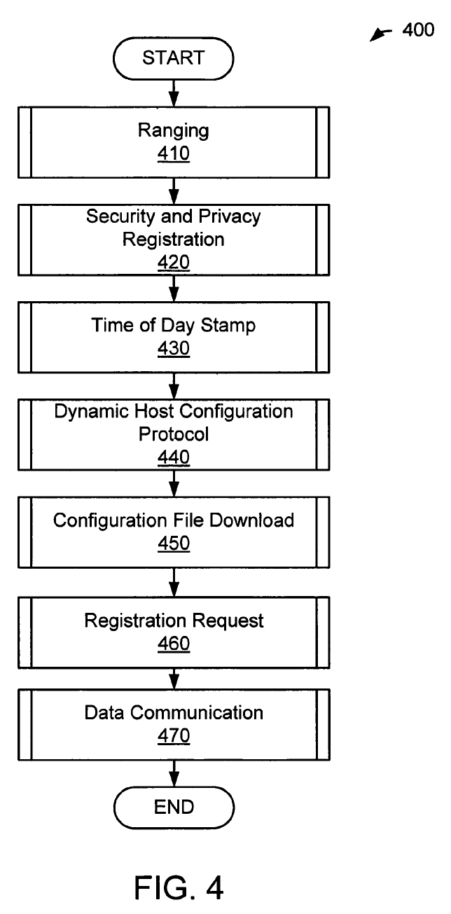

In one embodiment, a suspect cable modem may be detected and handled when such suspect cable is initiating data communication with the CMTS. Prior to describing such detection and suspect cable modem handling, a general process for a cable modem to establish data communication with a CMTS will first be described. FIG. 4 is a high-level flow chart illustrating one registration process for establishing communication between a cable modem 250 and a CMTS 120 according to one embodiment of the present invention. A two-way communication link cannot be established between a cable operator's head end 110 and a subscriber's cable modem 250 until the cable modem 250 has gone through a registration process with a CMTS 120. A process for establishing a communication link can comprise one or more of the following registration steps in any suitable order:

Downstream Frequency Search (not shown): The cable modem 250 scans the downstream channel looking for certain QAM (quadrature amplitude modulation) digitally modulated signals. Once a digital signal has been located, the cable modem, 250 looks for certain information on that signal which will have been sent by the CMTS 120. For example, the CMTS 120 will send information that identifies the upstream frequency, modulation type and channel bandwidth the cable modem 250 should use in order to communicate with the CMTS 120.

Ranging 410: After the cable modem 250 has located the digital signal from the CMTS 120, the cable modem 250 may then scan for a special type of message from the CMTS 120 called a map. A CMTS 120 map generally gives the cable modem 250 information concerning the windows of time (e.g., time slots) during which the cable modem may transmit, and other information necessary for transmitting data upstream to the CMTS 120.

Using this information, the cable modem 250 then typically transmits upstream data for the first time (initial maintenance), but the cable modem will do so without having information concerning the power, frequency and timing of communications with the CMTS 120. What follows is a “ranging” process in which the cable modem 250 initially sends a message using its lowest RF power to transmit. If the CMTS 120 does not respond, the modem will increase its transmit power slightly and try again. This initial message being sent in each of these attempts is called an initial range request. The cable modem 250 keeps increasing the transmit power of the initial range request until the CMTS is able to detect the range request. Once the CMTS detects the range request, it analyzes the power, frequency and timing of the range request and sends the cable modem 250 a range response, which includes instructions for the modem to adjust its transmit power, frequency and timing, to optimize communications with the CMTS 120. After the initial range request and response, additional range requests and response may be necessary for the cable modem 250 to fine tune its settings until the cable modem is transmitting at the proper power, frequency and timing.

In addition to this ranging that occurs as part of the registration process, the CMTS 120 may also repeat this ranging for every cable modem 250 in the network (e.g., at least once every 30 seconds pursuant to the DOCSIS protocol) in order to perform station maintenance. This periodic ranging can insure that all cable modems 250 are transmitting at the proper power, frequency and timing. Prior to adjustment, individual cable modems can transmit signals that are received by the head end at different power levels because of wide variances between the different signal paths between each cable modem and head end.

Dynamic Host Configuration Protocol (DHCP) 440: After the cable modem 250 has finished ranging with the CMTS 120, a communications link will have been established with the CMTS 120. Now, the modem can obtain additional information about the network, get an IP address, and get the name of a configuration file. All of these pieces of information may be obtained through a DHCP process. DHCP may take the form of a four-step process in which the cable modem 250 sends a DHCP discover message to a DHCP server connected to the IP network attached to the CMTS 120, and the server responds with a DHCP offer, the modem 250 sends an acceptance if the DHCP offer is acceptable to it, and the server responds with an ACK (acknowledgement) to complete the DHCP handshake. As part of this process, if the cable modem 250 has had its information registered on the server, as part of its DHCP offer, the DHCP server will send the name of the configuration file that the cable modem should download from the specified configuration file server. As discussed further below, the cable modem downloads the configuration file and uses the parameters continued in the configuration file to register with the CMTS.

Time of Day (ToD) 430: A ToD server may provide a timestamp to cable modems 250 during registration. If this process is available, the modem 250 can request a ToD stamp from the ToD server, and then receive a response form the ToD server. The ToD server was required for the initial version of DOCSIS networks, but the ToD has not been required by subsequent revisions of the DOCSIS. Nonetheless, the ToD feature is still often used.

Configuration File Download—Trivial file transfer protocol (TFTP) 450: The cable modem 250 typically also downloads the configuration file whose name was provided during the DHCP process. This step typically has to succeed in order for the modem 250 to continue to the rest of the registration process. In certain embodiments of the invention, this step is initiated by the modem 250 sending a TFTP read request to the IP address of the TFTP server with the configuration file name obtained during the DHCP process. The TFTP server's IP address is also obtained during the DHCP process. If the configuration file name exists on the TFTP server, the server downloads the configuration file to the cable modem 250. The modem 250 will typically acknowledge the configuration file download if such download is free of errors and occurs properly.

The configuration file contains important information concerning the level of service the cable modem 250 is to receive. Notably, the configuration file provides the cable modem 250 with settings for the maximum subscriber data download and upload speeds, quality of service (QoS) settings, DOCSIS 1.1 settings, encryption settings, etc.

Theft of service attempts may take the form of intercepting, modifying the configuration file, substituting the authorized configuration file with an unauthorized configuration file, downloading the configuration file from a local TFTP server. To address this problem, in an alternative embodiment, in addition to the above described process, a CMTS may allow the cable modems to download a configuration file over the cable interface, through the CMTS, so that the CMTS may act as a TFTP server, providing dynamically generated DOCSIS configuration files to cable modems. This approach may serve to prevent a common type of theft of service attack, in which a user attempts to download a modified DOCSIS configuration file from a local TFTP server.

In another embodiment, a cable operator may use a shared secret password to calculate a CMTS Message Integrity Check (MIC) field that is attached to all DOCSIS configuration files. In this embodiment, the cable modem must include its calculation of the CMTS MIC in its registration request, along with the contents of the configuration file. If a user modifies any of the fields in the DOCSIS configuration file, or uses a different shared secret value, the CMTS can determine that when the cable modem registers based on the CMTS MIC value. If such modification occurs, the CMTS may not allow the cable modem to register, and may mark it as being in a reject state. However, in certain inventive embodiments the cable modem may be allowed to register even when such modification has occurred as further described below. In another embodiment, the cable operator may implement time stamps, and use modem specific configuration files in addition to the above described processes.

Registration request 460: Finally, the modem 250 may be ready to register with the CMTS 120. The modem 250 may send a registration request to the CMTS 120 containing information concerning, among other settings, the configuration settings of the modem, such settings as the modem's maximum uploading and downloading speeds, and the QoS profile, among other things. The CMTS 120 may inspect the information to make sure it is valid, and if approved, will typically send the modem a response indicating a successful registration. If the CMTS 120 sees something wrong or suspicious in the modem's 250 settings or request, the CMTS 120 has the ability to reject the cable modem 250 by sending the cable modem a message indicating rejection. The cable modem may not then be able to come online and transmit data.

In addition, according to some embodiments of the present invention, if the CMTS sees that a cable modem has made a series of improper registration attempts exceeding some predetermined number, the CMTS may put the cable modem on a suspect cable modems list, and then the CMTS may downgrade the service level used to communicate with the cable modem. For example, instead of sending the cable modem a reject message as the CMTS had previously, the CMTS may send the cable modem a successful registration message, but then without notifying the cable modem provide the cable modem with a lower level of services, as described further below.

Security and Privacy Registration (BPI/BPI+, option) 420: Security and Privacy Registration is a feature that is frequently implemented by cable operators. One embodiment of a Security and Privacy Registration system is Baseline Privacy Interface Plus (BPI+). BPI+ provides a secure link between a cable modem and CMTS, preventing users from intercepting or modifying packets that are transmitted over the cable interface. This option does this by providing a mechanism for encrypting and protecting subscriber data while such data is being transmitted over the RF network. This option can also provide for secure authorization of cable modems, using digital certificates. Digital certificates can provide a mechanism for preventing nonpaying subscribers from getting broadband service with hacked cable modems. Finally, this option may also provide a secure software download capability that ensures software upgrades are not spoofed, intercepted, or altered.

The BPI registration process, if enabled, can occur immediately after ranging—after the cable modem 250 has established a connection with the CMTS 120. BPI can take the form of a four-step process that involves public and private keys and their authentication. The public and private keys are exchanged between the cable modem and CMTS 120, along with the expiration times of the keys.

It is worth noting that in some versions of DOCSIS, for example, in DOCSIS 3.0, the security and privacy registration process may occur earlier in the overall modem registration process. It may, for example, occur prior to the DHCP step, as shown in FIG. 4. As also shown in FIG. 4, the Time of Day stamp process may also occur at different points in the registration process. As noted above, the particular order of steps in the registration process may diverge from the ones described in the above description or shown in the Figures; the description of specific embodiments does not limit the ways the steps of the registration process may occur.

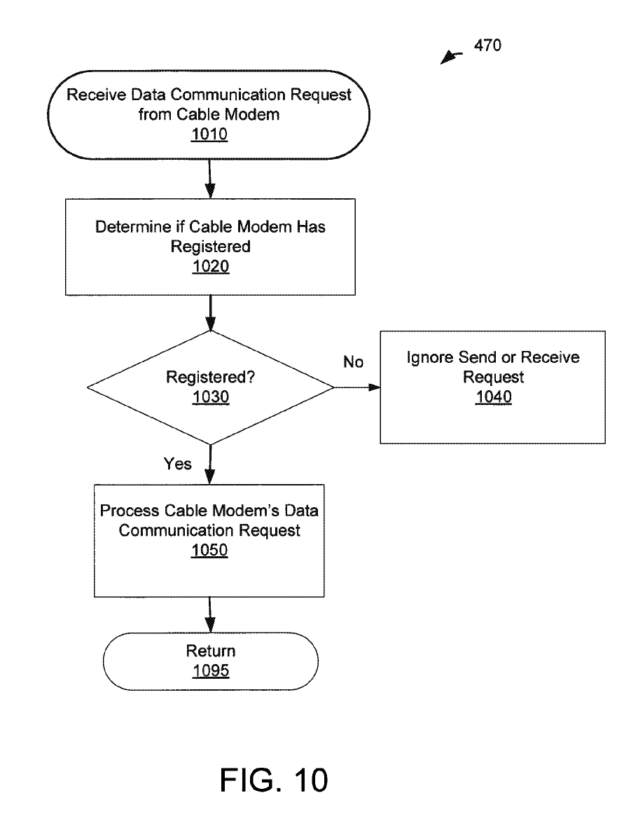

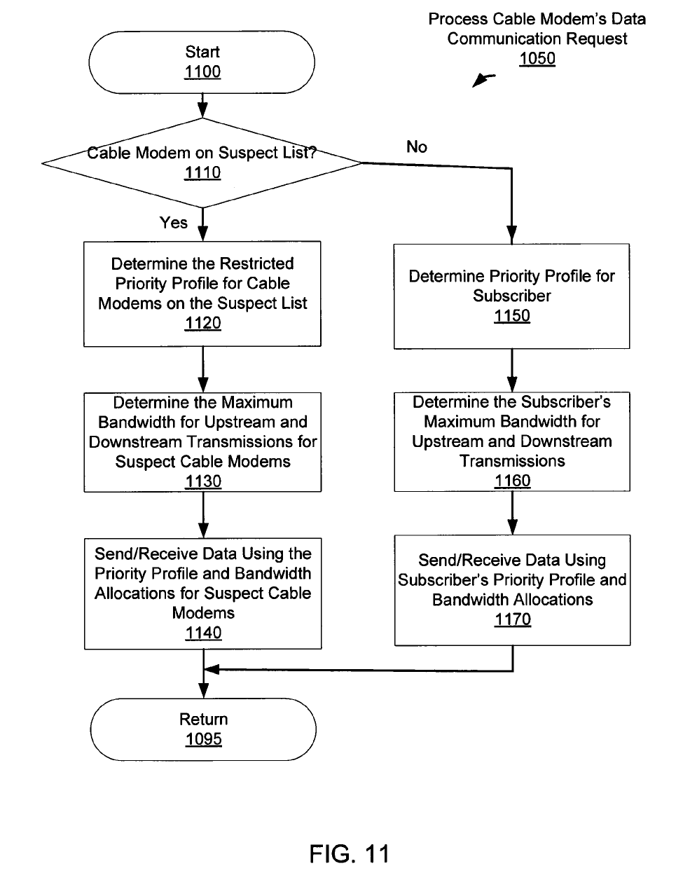

After the above registration process between a CMTS and a cable modem is completed, two-way communication can be conducted between the head end and the cable modem that wishes to communicate with the head end. In the data communication step 470, the cable modem 250 is able to send and receive data, voice and video signals from the CMTS 120. Numerous requests to send or receive data may be sent back and forth between the cable modem 250 and the CMTS 120. One example process by which these requests may be handled is set forth in the flow diagrams depicted in FIGS. 10 and 11 (described further below).

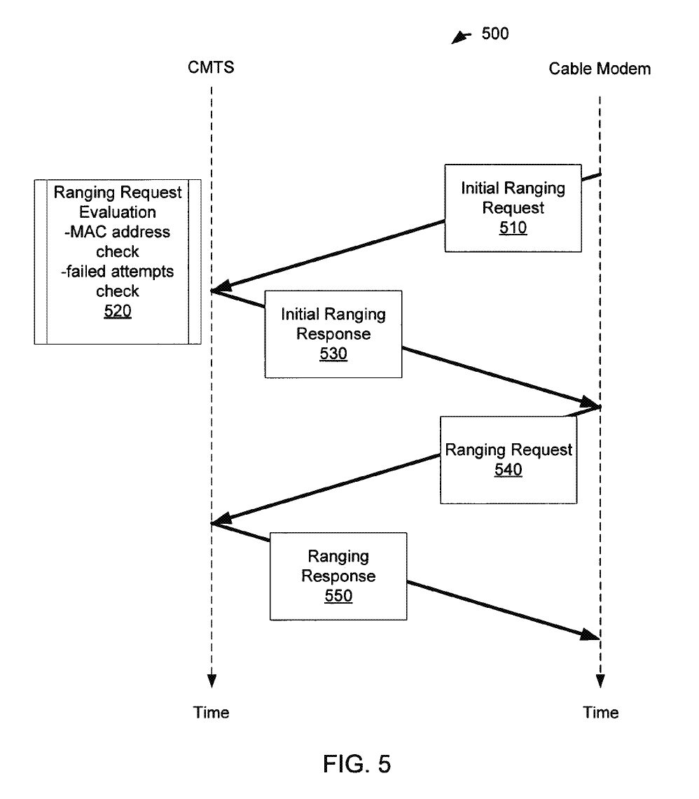

Specific implementations of the ranging, DHCP, configuration file, and registration request processes touched upon above are described in further detail in the handshaking diagrams contained in FIGS. 5-9. FIG. 5 is a handshaking diagram showing ranging related communications 500 between the cable modem 250 and the CMTS 120 establishing a connection between a cable modem 250 and a CMTS 120 according to a specific implementation of the present invention. During a ranging process, the cable modem 250 may send an initial ranging request 510, In response to such initial request, the CMTS may send an initial ranging response 530. The cable modem may then respond by sending a subsequent ranging request 540, to which the CMTS responds with a further ranging response 550. As described above, the cable modem and CMTS may continue to periodically send ranging requests and responses to each other.

As part of a Ranging Request Evaluation process (520) shown in the diagram, in some embodiments of the invention, the CMTS may check the MAC address of the cable modem (e.g., sent in the initial ranging request 510 or a subsequent ranging request 540) against a list of cable modems provisioned on the configuration file server, to confirm the cable modem 250 is that of a subscriber (e.g., not a clone modem). If the cable modem is not on the list, the CMTS may limit the number of times the cable modem is sent a range response, or take other measures to ensure that the cable modem is not permitted to drain system resources. If the cable modem does not appear to correspond to a subscriber, the CMTS may keep track of the number of attempts to range with an improper MAC address (e.g., as specified in an initial ranging request 510 or a subsequent ranging request 540), and if this occurs over a predetermined number of times, may place the cable modem on a suspect cable modems list. When a modem is placed on a suspect cable modem list, mechanisms may then be applied to such modem to downgrade its service level as further described below.

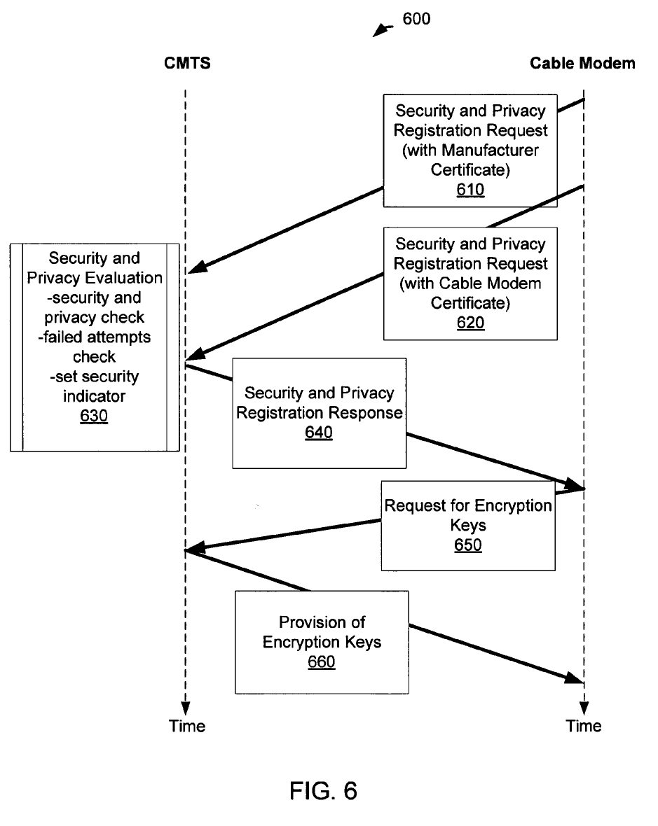

FIG. 6 is a handshaking diagram showing a series of communications between a cable modem 250 and a CMTS 120 carrying out a cable modem's security and privacy registration according to one embodiment of the present invention. During a security and privacy registration process, the cable modem 250 may send an initial security and privacy registration request containing a manufacturer certificate 610. The cable modem may then send a second security and privacy registration request containing a cable modem certificate 620. In response to such requests, the CMTS may respond with a security and privacy registration response 640; this can complete the authentication phase of the process. The cable modem may then respond by sending a request for encryption keys 650, to which the CMTS may respond by providing encryption keys 660.

As part of the Security and Privacy Evaluation pictured in FIG. 6, the CMTS 120 may check whether the certificates provided by the cable modem 250 are proper. For example, the certificates must be properly signed, linked, and originating from the proper sources (e.g., as previously predefined for such cable modem). If the cable modem 250 fails the security registration process a predetermined number of times, the CMTS may place the cable modem on the suspect cable modems list. In addition, the CMTS may set a security indicator for such cable modem to show that the cable modem is not secure. The security indicator may be a separate indicator from the suspected cable modems list, and may be used in some embodiments of the invention to ensure that certain private information about the subscriber is not divulged to the cable modem (e.g., and its associated non-subscribing hacker).

While the cable modem 250 is still in the state where it has failed this registration step, but has not yet failed this registration step a predetermined number of times (so it is not yet a suspect cable modem), the CMTS's 120 response to the cable modem may indicate that the cable modem 250 has failed its Security and Privacy Registration. However, after the cable modem 250 fails this step more than the predetermined number of times and is deemed a suspect cable modem, the CMTS's 120 response might indicate that the registration has been successful.

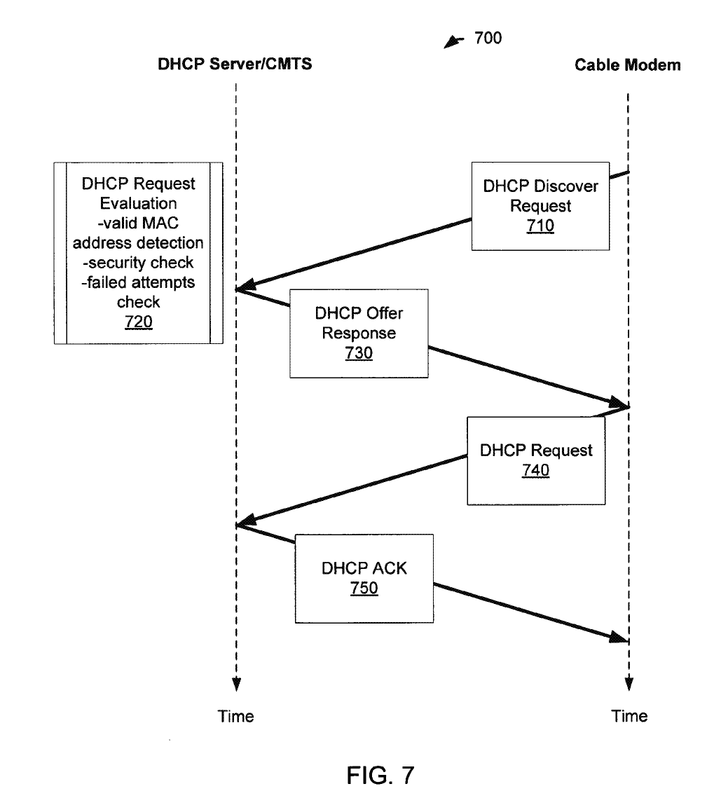

FIG. 7 is a handshaking diagram showing a series of communications between the cable modem 250 and the DHCP Server/CMTS 120 carrying out the DHCP protocol 250 in accordance with one embodiment of the present invention. During a DHCP protocol process, the cable modem 250 may send an initial DHCP discover request 710, In response to such initial request, the CMTS may send DHCP offer response 730. The cable modem may then respond by sending a DHCP request 740, to which the CMTS responds with a DHCP ACK (acknowledgment) 750.

As part of the DHCP process, the cable modem 250 may receive an IP address, a gateway address, a DNS server address, as well as other important network information, as is usually received in a DHCP process. In addition, the cable modem 250 may also receive an IP address for a configuration file server, which in some embodiments is a TFTP server, and a name for the configuration file on such file server. The named configuration file corresponds to the cable modem. As part of the DHCP Request Evaluation indicated in FIG. 7, the CMTS 120 may review the MAC address of the cable modem to confirm that the configuration file server has been provisioned with a configuration file for the MAC address of the requesting cable modem. Other identifiers, besides a MAC address, may be used to determine whether the requested configuration file corresponds to an identity of the requesting cable modem.

In addition, before giving out a configuration file name, the CMTS may determine whether the security indicator, if one exists, is on or off, to determine whether the cable modem 250 has passed a previously performed security and privacy registration step. If it appears that the cable modem 250 has failed a security and privacy registration process, then the CMTS may not provide the cable modem with the requested configuration file name, but rather provide a dummy configuration file's name. The dummy configuration file may contain configuration settings for a restricted level of service. If in addition, the number of times the cable modem has attempted DHCP discover request exceeds a predetermined number of times, the cable modem 250 may be placed by the CMTS 120 on a suspect cable modems list. Further, the cable modem in this second circumstance may also be provided a DHCP offer response that indicates the registration is successful.

If the DHCP server is a separate device from the CMTS, the cable modem may communicate with the DHCP server via the CMTS so that the CMTS may perform the DHCP Request Evaluation 720 based on such DHCP communication. Alternatively, the DHCP Request Evaluation 720 may be performed by the DHCP server itself, as opposed to the CMTS.

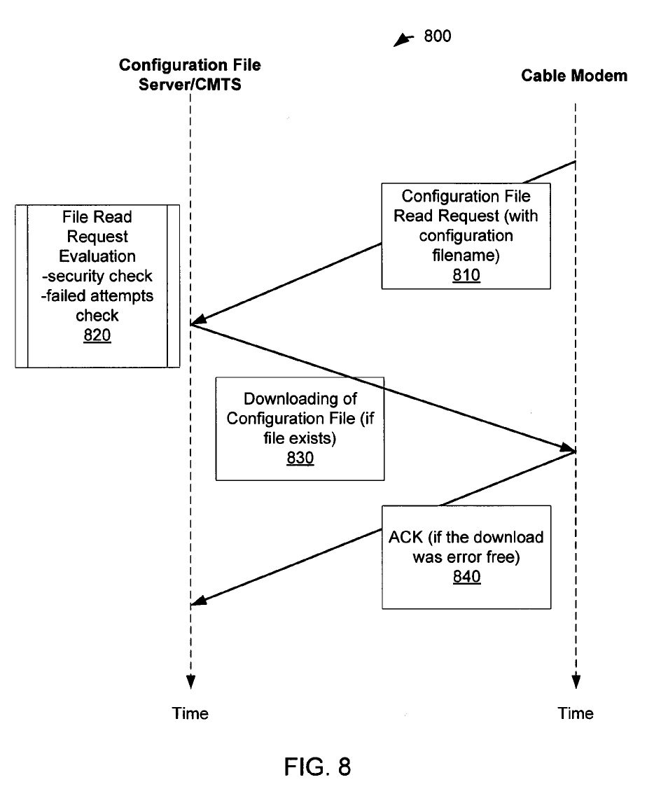

FIG. 8 is a handshaking diagram showing a series of communications between the cable modem 250 and the Configuration File Server/CMTS 120 carrying out a process for providing a configuration file to the cable modem 250 according to one embodiment of the present invention. During a configuration file download process, the cable modem 250 may send a configuration file read request including the configuration filename it received from the DHCP process above 810. In response to such initial request, the CMTS may download the configuration file, if a file corresponding to the filename exists 830. The cable modem may then respond by sending a subsequent message acknowledging the download if the download was error free 840.

As part of the process, the cable modem 250 may make a read request 810 for a specific configuration file, using the configuration file name given by the DHCP server. In a File Read Request Evaluation 820 indicated in FIG. 8, the Configuration File Server/CMTS may determine whether the cable modem 250 is requesting a legitimate file; if so, the cable modem 250 may be provided with such file (830). If the cable modem 250 has previously failed a security and privacy registration step, the cable modem 250 may receive a dummy configuration file name, which corresponds to a configuration file with a list of restricted configuration settings.

The Configuration File Server/CMTS may also look at the security indicator to confirm that the cable modem has been found to be secure before handing out a legitimate configuration file. In addition, if the cable modem attempts unsuccessfully to obtain a configuration file more than a predetermined number of times, the Configuration File Server/CMTS may place the cable modem 250 on a suspect cable modem list. If the cable modem is suspect, the Configuration File Server/CMTS may give the cable modem 250 a dummy configuration file (830), to which the cable modem may return an ACK response 840 if the downloaded configuration file was error free. For instance, the Configuration File Server/CMTS downloads a dummy configuration file containing a restricted quality of service profile and restricted maximum bandwidths to the cable modem 250 without informing the cable modem 250. Alternative embodiments of this step are described above.

If the configuration file server is a separate device from the CMTS, the cable modem may communicate with the configuration file server via the CMTS so that the CMTS may perform the File Read Request Evaluation 820 based on such configuration file server communication. Alternatively, the File Read Request Evaluation 820 may be performed by the configuration file server itself, as opposed to the CMTS.

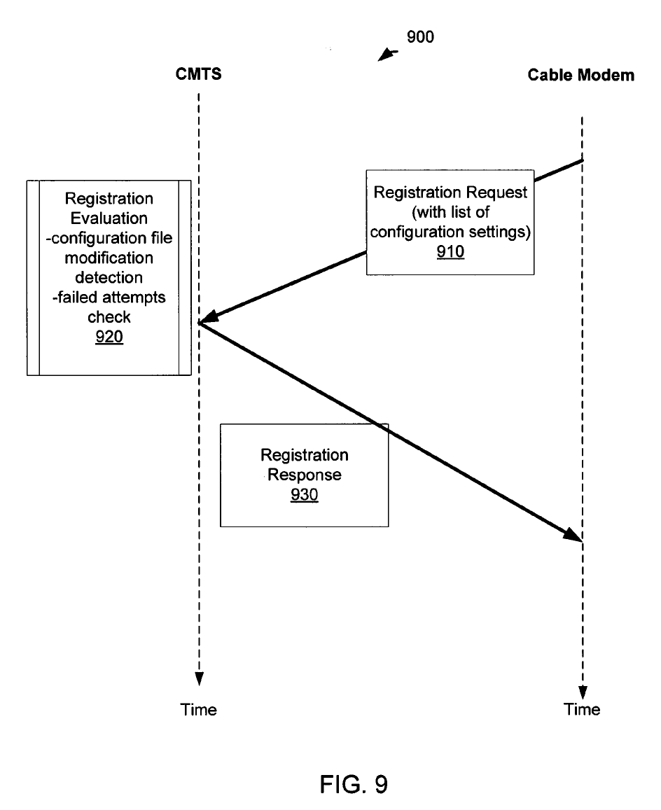

FIG. 9 is a handshaking diagram showing a series of communications between the cable modem 250 and the CMTS 120 carrying out a registration request operation of a registration process according to one embodiment of the present invention. As shown, a cable modem may initially send a registration request 910 that contains a list of configuration settings for such cable modem. The CMTS may return a registration response 930 as further described herein.

As part of a Registration Evaluation (920) indicated in FIG. 9, the CMTS 120 may check to see if the configuration settings provided by the cable modem 250 are consistent with the ones contained in the configuration file given to the cable modem. If it appears that the cable modem 250 has modified any of its configuration file settings, the CMTS may increment the failed attempts counter for this step. If the counter is already at the predetermined number, the CMTS may place the cable modem 250 on the suspect cable modems list. Furthermore, before the cable modem 250 reaches the predetermined number of failed attempts, the CMTS 120 may inform the cable modem 250 that the cable modem's 250 registration request has been rejected. However, after the cable modem 250 fails this step more than the predetermined number of times, the CMTS 120 may send the cable modem 250 a message indicating that registration has been successful while downgrading the service level to such cable modem as described further herein.

FIG. 10 is a high level flow chart illustrating a procedure for managing data communication between a CMTS and a cable modem 250 according to one embodiment of the present invention. In the data communication process 470 that occurs subsequent to a successful registration of a cable modem, numerous requests to send or receive data may be sent back and forth between the cable modem 250 and the CMTS 120. The process by which these requests are handled is set forth at a high level in FIG. 10. Initially, a data communication request from a cable modem is received by the CMTS in operation 1010. It may then be determined whether the cable modem is already registered in operation 1020. If the cable modem has already been registered, then the CMTS may proceed 1030 to process the data communication request from the cable modem 1050. This manner in which the cable modem's data communication request is processed is described in further detail in FIG. 11. If, however, the cable modem has not already been registered, in one embodiment of the invention, the CMTS may ignore the data communication request 1040.

FIG. 11 is a flow chart illustrating a method for processing a data communication request from a cable modem 250 to a CMTS 120. Generally, a CMTS may allow a cable modem to send or receive data according to the configuration settings in its configuration file. The present invention envisions a circumstance where a CMTS 120 downgrades how data is handled for suspect cable modems, irregardless of configuration file settings. In one embodiment, the CMTS determines a cable modem is suspect, and rather than sending the cable modem a reject message, the CMTS sends a successful registration message. Then instead of providing the cable modem 250 service at its usual level during the data communication step, the CMTS 120 provides the cable modem 250 with service at a lower level. For example, the CMTS might provide the cable modem 250 with data at an extremely low bandwidth. FIG. 11 illustrates a method by which a CMTS might treat a data request from a cable modem differently if the cable modem is on a suspect cable modem list.

Initially, it may be determined whether a cable modem, which is attempting data communication, is on the suspect cable modem list in operation 1110. If the cable modem is not on such suspect cable modems list, the priority profile for the subscriber may then be determined in operation 1150. The subscriber's maximum bandwidth for upstream and downstream transmission may also be determined in operation 1160. For example, the priority profile and maximum bandwidth for upstream and downstream transmissions may be determined based on the cable modem's provided configuration file. Data is then sent or received using the subscriber's priority profile and bandwidth allocations in operation 1170.

If, however, it is determined that the cable modem is on such suspect cable modems list, and so has been found to be suspect, a different procedure is followed. The restricted priority profile for those on the suspect cable modems list may then be determined in operation 1120. The maximum bandwidth for upstream and downstream transmission for suspect cable modems may also be determined in operation 1130. For example, the priority profile and maximum bandwidth for upstream and downstream transmissions to be used with suspect cable modems may be stored in a memory storage device on the CMTS. Data is then sent or received using the restricted priority profile and bandwidth allocations in operation 1140.

In FIG. 11, determining a restricted priority profile 1120 and a restricted bandwidth 1130 to give to a suspect modem can be a simple process when there is only one priority profile and one bandwidth to be allocated to all cable modems on the suspect cable modems list. In an alternative embodiment, steps 1120 and 1130 may involve selecting from one of several different configuration files (each including a different priority profile and bandwidth) to assign to a suspect cable modem depending on a number of different factors. Such factors might include one or more of the same factors that served as a basis for a cable modem being assigned to the suspect class, the number of times a cable modem has failed a registration step within a predetermined period of time, and/or an amount of traffic currently being serviced by the head end, among other factors.

In an alternative embodiment, cable operators may be given the option of deciding which response among several to take when a cable modem fails a registration step, the options including one or more of the following: (1) rejecting the registration request and refusing to allow the user to come online until a valid registration is completed, (2) locking the cable modem in a restricted quality of service (QoS) configuration until the modem remains offline for some predetermined period of time, or (3) marking that cable modem and allowing the user online.

Generally, techniques of the present invention may be implemented in software and/or hardware. By way of examples, embodiments of the present invention can be implemented in an operating system kernel, in a separate user process, in a library package bound into network applications, on a specially constructed machine, or on a network interface card. In a specific embodiment of this invention, the techniques of the present invention are implemented in software such as an operating system or in an application running on an operating system.

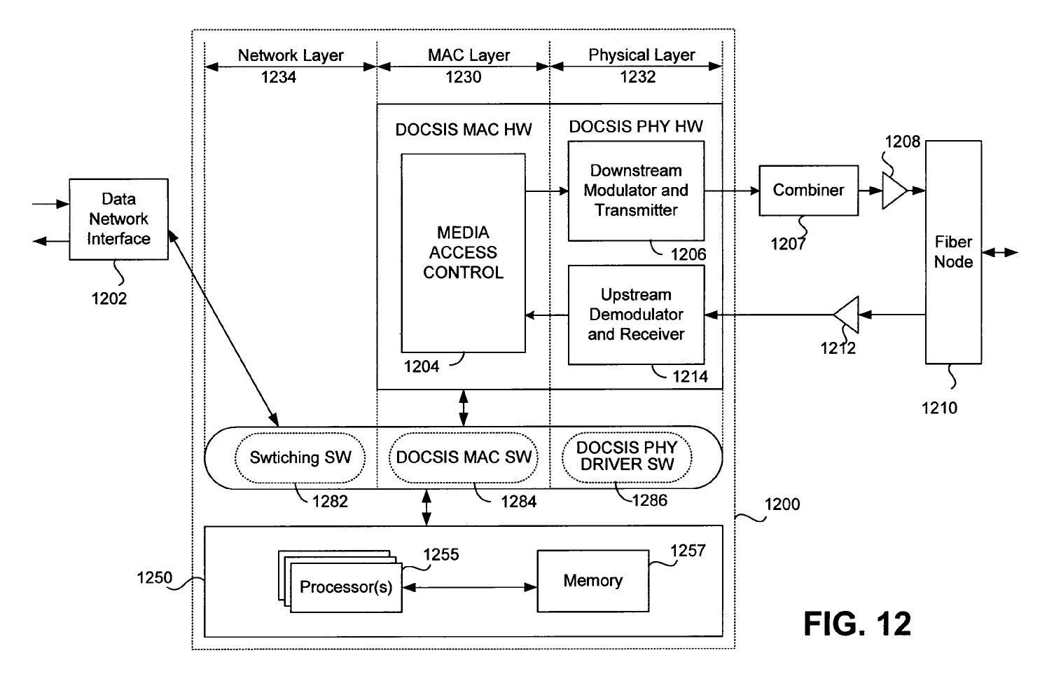

FIG. 12 is a diagrammatic representation illustrating the basic components of a Cable Modem Termination System (CMTS), represented by block 1200. In a specific embodiment as shown, for example, in FIG. 12, the CMTS implements three network layers, including a physical layer 1232, a Medial Access Control (MAC) layer 1230, and a network layer 1234. When a modem sends a packet of information (e.g. data packet, voice packet, etc.) to the CMTS, the packet is received at fiber node 1210. Each fiber node 1210 can generally service about 500 subscribers, depending on bandwidth. Converter 1212 converts optical signals transmitted by fiber node 1210 into electrical signals that can be processed by upstream demodulator and receiver 1214. The upstream demodulator and receiver 1214 is part of the CMTS physical layer 1232. Generally, the physical layer is responsible for receiving and transmitting RF signals on the HFC cable plant. Hardware portions of the physical layer include downstream modulator and transmitter 1206 and upstream demodulator and receiver 1214. The physical layer also includes device driver software 1286 for driving the hardware components of the physical layer.

Once an information packet is demodulated by the demodulator/receiver 1214, it is then passed to MAC layer 1230. A primary purpose of MAC layer 1230 is to coordinate channel access of multiple cable modems sharing the same cable channel. The MAC layer 1230 is also responsible for encapsulating and de-encapsulating packets within a MAC header according to the DOCSIS standard for transmission of data or other information.

MAC layer 1230 includes a MAC hardware portion 1204 and a MAC software portion 1284, which function together to encapsulate information packets with the appropriate MAC address of the cable modem(s) on the system. Note that there are MAC addresses in the cable modems which encapsulate data or other information to be sent upstream with a header containing the MAC address of the hub associated with the particular cable modem sending the data.

Each cable modem on the system has its own MAC address. Whenever a new cable modem is installed, its address is registered with MAC layer 1230. The MAC address is important for distinguishing data sent from individual cable modems to the CMTS 120. Since all modems on a particular channel share a common upstream path, the CMTS 120 uses the MAC address to identify and communicate with a particular modem on a selected upstream channel. Thus, data packets, regardless of format, are mapped to a particular MAC address.

MAC layer 1230 is also responsible for sending out polling opportunities as part of the link protocol between the CMTS and each of the cable modems on a particular channel. As discussed above, these polling opportunities are important for maintaining communication between the CMTS and the cable modems (e.g., by providing opportunities for periodic ranging).

The CMTS 120 can control the amount of data traffic on the upstream and downstream communication channels between the CMTS 120 and the cable modem 250. It can control the downstream bandwidth, that is, the rate at which the CMTS 120 transmits data to the cable modem by simply lowering the rate at which it sends packets to the cable modem 250. With respect to upstream traffic where the cable modem sends data to the CMTS 120, the CMTS 120 can control the bandwidth of the upstream traffic by indicating to the cable modem 250 as part of a mapping process that the cable modem 250 can transmit data to the CMTS 120 on a less frequent basis. For example, the mapping process may involve the CMTS 120 dividing the channel into small increments and assigning a certain fraction of the channel to each cable modem 250, and then communicating to each cable modem 250 the time slot during which they can send data upstream. The part of the CMTS 120 that controls the bandwidth provided to a particular cable modem 250 may receive instructions as to the amount of bandwidth it should provide to a cable modem through a variety of means, including Simple Network Management Protocol (SNMP) and command line interfaces (CLI), among other technologies.

Regardless of network device's configuration, the CMTS 120 may employ one or more memories or memory modules configured to store program instructions for the general-purpose network operations and mechanisms for adjusting the power level of one or more cable modems described herein. The program instructions may control the operation of an operating system and/or one or more applications, for example. The memory or memories may also be configured to store security indicators, failed attempt counters, time of last failed attempt indicators, one or more lists of suspect cable modems, etc., as described above.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave travelling over an appropriate medium such as airwaves, optical lines, electric lines, etc. Examples of program instructions include both machine code, such as produced by a compiler, and files containing higher level code that may be executed by the computer using an interpreter.

What is claimed is:

1. A method comprising:
determining in a cable modem termination system that a cable modem seeking to access cable services is suspect,
wherein it is determined that the cable modem is suspect when such cable modem is attempting or performing one or more of a plurality of predefined suspect activities;
categorizing the cable modem as suspect after it is determined that the cable modem is suspect;
indicating to the cable modem that it has been approved for cable services at a first service level after it is determined that the cable modem is suspect; and
providing cable services to the cable modem at a second service level after it is determined that the cable modem is suspect,
wherein the second service level is lower than the first service level.

2. The method of claim 1, wherein the first service level is requested by the cable modem.

3. The method of claim 1, wherein the second service level is a predetermined service level provided by the cable modem termination system to suspect cable modems.

4. The method of claim 3, wherein the second service level comprises a bandwidth allocation and/or a priority profile.

5. The method of claim 1, wherein the cable modem is determined to be suspect after the cable modem fails an authentication process a predetermined number of times.

6. The method of claim 1, wherein the cable modem is determined to be suspect when the cable modem's configuration settings have been modified without permission.

7. The method of claim 1, wherein the cable modem is determined to be suspect when the cable modem is determined to be a clone cable modem.

8. An apparatus comprising:
one or more processors; and
one or more memory, wherein at least one of the one or more processors and memory are configured to perform the following operations:
determining in a cable modem termination system that a cable modem seeking to access cable services is suspect,
wherein it is determined that the cable modem is suspect when such cable modem is attempting or performing one or more of a plurality of predefined suspect activities;
categorizing the cable modem as suspect after it is determined that the cable modem is suspect;
indicating to the cable modem that it has been approved for cable services at a first service level after it is determined that the cable modem is suspect; and
providing cable services to the cable modem at a second service level after it is determined that the cable modem is suspect,
wherein the second service level is lower than the first service level.

9. The apparatus of claim 8, wherein the first service level is requested by the cable modem.

10. The apparatus of claim 8, wherein the second service level is a predetermined service level provided by the cable modem termination system to suspect cable modems.

11. The apparatus of claim 10, wherein the second service level comprises a bandwidth allocation and/or a priority profile.

12. The apparatus of claim 8, wherein the cable modem is determined to be suspect after the cable modem fails an authentication process a predetermined number of times.

13. The apparatus of claim 8, wherein the cable modem is determined to be suspect when the cable modem's configuration settings have been modified without permission.

14. The apparatus of claim 8, wherein the cable modem is determined to be suspect when the cable modem is determined to be a clone cable modem.

15. An apparatus comprising:
means for determining in a cable modem termination system that a cable modem seeking to access cable services is suspect,
wherein it is determined that the cable modem is suspect when such cable modem is attempting or performing one or more of a plurality of predefined suspect activities;
means for categorizing the cable modem as suspect after it is determined that the cable modem is suspect;
means for indicating to the cable modem that it has been approved for cable services at a first service level after it is determined that the cable modem is suspect; and
means for providing cable services to the cable modem at a second service level after it is determined that the cable modem is suspect,
wherein the second service level is lower than the first service level.

16. At least one computer readable storage medium having computer program instructions stored thereon that are arranged to perform the following operations:
determining in a cable modem termination system that a cable modem seeking to access cable services is suspect,
wherein it is determined that the cable modem is suspect when such cable modem is attempting or performing one or more of a plurality of predefined suspect activities;
categorizing the cable modem as suspect after it is determined that the cable modem is suspect;
indicating to the cable modem that it has been approved for cable services at a first service level after it is determined that the cable modem is suspect; and
providing cable services to the cable modem at a second service level after it is determined that the cable modem is suspect,
wherein the second service level is lower than the first service level.

17. The at least one computer readable storage medium as recited in claim 16, wherein the first service level is requested by the cable modem.

18. The at least one computer readable storage medium as recited in claim 16, wherein the second service level is a predetermined service level provided by the cable modem termination system to suspect cable modems.

19. The at least one computer readable storage medium as recited in claim 18, wherein the second service level comprises a bandwidth allocation and/or a priority profile.

20. The at least one computer readable storage medium as recited in claim 16, wherein the computer program instructions are further arranged to perform the following operation: determine that the cable modem is suspect after the cable modem fails an authentication process a predetermined number of times.
